(19) United States
(12) Patent Application Publication
(10) Pub. No.: US 2008/0153073 A1
(43) Pub. Date: Jun. 26, 2008

(54) Educational card game and method of play

(76) Inventor: Gen-Tnao Hsia, Mission Viejo, CA (US)

Correspondence Address: Joe McKinney Muncy, PO Box 1364, Fairfax, VA, 22038-1364, US

(21) Appl. No.: 11/642,922

(22) Filed: Dec. 21, 2006

(51) Int. Cl. G09B 19/22

(52) U.S. Cl. 434/129

(57) ABSTRACT

The present invention is an educational card game and a method of play thereof, wherein the deck of cards includes at least two cards, each recording information that represents the key concepts from one or more educational topic(s), such that the key concepts comprise part of or all of the contents of the specific topic. Each card must be mutually associated with at least one other card through similar meaning or other logical ties. Through playing the game, players are encouraged to collect associated cards, and they will thus be able to quickly understand the key concepts of a topic, as well as how key concepts are related to each other. The present invention enhances the players' learning experience and serves as an effective educational support tool.

The present invention is an auxiliary learning tool. Specifically, it comprises an educational card game for learning and a method of play thereof.

### BACKGROUND OF THE INVENTION

There are many kinds of patented cards and card games already existing that are designed to aid players in learning some particular knowledge during the playing process. One method of such learning is by reading the information or knowledge printed on the playing cards; for example, U.S. Pat. No. 6,910,893 disclosed a card game including different suits, each of which record different educational topics, such as mathematics, geography, history, etc. Another method is to let the players learn via answering questions; that is, each card has only a question printed thereon and the player must correctly answer that question to ‘win’ that card; for example, U.S. Pat. No. 6,447,300 and U.S. Pat. No. 7,029,281 utilize this question and answer model, where players must answer questions correctly and collect cards. However, the questions in these card games seem to focus chiefly on mathematical formulas; each card has only one correct answer, and the contents of the cards lack any association amongst themselves.

The cards and card games described above are limited in their possible variations and are furthermore restricted to each specified field of knowledge. That is to say, the knowledge is fixed within the limited content of the cards. For example, U.S. Pat. No. 6,910,893 describes a card game that only requests the player to recite out loud the contents of the cards that he or she wins; and U.S. Pat. No. 5,690,336 describes a card game that is limited to learning about administration or geography. The knowledge that can be learned in these current examples is limited, and the game contents lack effective expandability or association between topics.

### SUMMARY OF THE INVENTION

The object of the present invention is to provide a deck of educational playing cards as a learning tool. The preferred embodiment of the present invention includes a deck of at least two cards, with each card containing some information from a particular source, such as articles, idiomatic phrases, poems, stories or scientific knowledge, etc. such that the information on these cards are associated with each other.

By ‘association’, we mean that the information recorded on each of a collection of associated cards represents all or part of the content of a single educational topic. Furthermore, an association may mean that the information on the cards have a connection either through meaning or through logic, even if between differing topics.

One objective of the present invention is to provide a method for using a deck of educational cards as a learning tool. Through the game play, the players are encouraged to collect associated cards, and furthermore to understand and assimilate the knowledge recorded on the cards, thus serving its role as an educational tool. In a preferred embodiment, sets of cards from different sources may be mixed and played together, thus expanding the range of knowledge.

The present invention also provides a method of manufacturing a deck of educational playing cards. To achieve the objective described above, pieces of relevant information are recorded separately on two or more cards. Through game play, this deck of cards encourages players to collect the associated cards, and furthermore to understand and assimilate the knowledge recorded on the cards, thus serving its role as an educational tool.

The suggested method for achieving the objective of the present invention, described above, includes the following steps:

1. Decide on an educational topic (such as a story or an article, etc.);

2. Collect information related to the topic;

3. Separate the information into key concepts; and

4. Record the key concepts onto a deck of two or more playing cards, such that each card contains exactly one of the key concepts.

### BRIEF DESCRIPTION OF THE DRAWINGS

The foregoing aspects and many of the attendant advantages of the present invention will be more readily appreciated and understood given the following detailed description, and when taken in conjunction with the accompanying drawings:

FIG. 1 is a schematic view showing the obverse sides of the cards in a preferred embodiment of the present invention;

FIG. 2 is a schematic view showing the reverse sides of the cards in a preferred embodiment of the present invention;

FIG. 3 is an example of the playing cards;

FIG. 4 is another example of the playing cards; and

FIGS. 5A and 5B are flow charts showing the typical steps involved during game play according to a preferred embodiment of the present invention.

### DESCRIPTION OF THE PREFERRED EMBODIMENT

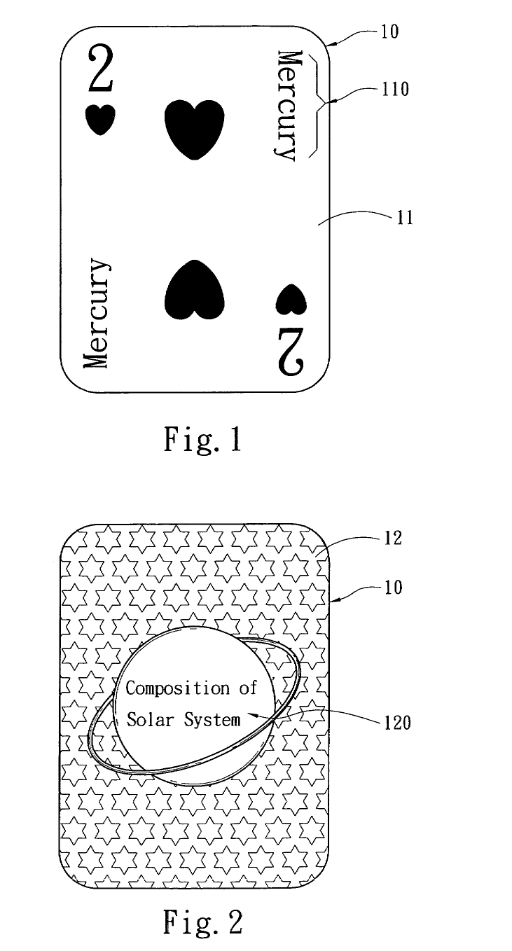

The educational card game of the present invention includes a deck of cards 10 as shown in FIGS. 1 through 4, each card having an obverse side 11 as shown in FIGS. 1, 3, and 4 and a reverse side 12 as shown in FIG. 2.

For each card 10, the obverse side 11 has an information area 110 where the key concepts are recorded, as determined by the learning topic. The key concepts can represent all or part of the content of an educational topic, such as articles, idiomatic phrases, poems, stories etc., such that the information on at least two cards 10 have key concepts that are mutually associated. The information recorded on the cards can be in the form of characters, symbols, figures or any combination thereof. Furthermore, the reverse side 12 of each card 10 may also include a marking area 120 as shown in FIG. 2 for indicating its educational topic.

The method of manufacturing the educational playing cards includes the following steps:

1. Select an educational topic (such as a story or an autobiography);

2. Collect information or knowledge related to the educational topic, which will comprise the material that is to be learned;

3. Separate the information into key concepts; and

4. Record each key concept on the playing cards, such that each card 10 contains exactly one of the key concepts.

The following are some examples for manufacturing the educational playing cards according to the present invention.

### EXAMPLE I

Educational Topic: Brief Introduction of the “Jaguar”

Educational content: “The Jaguar belongs to the Panthera genus and is the third largest species in the Felidae family, and its appearance is extremely similar to the Leopard. However, the Jaguar is more thickset than the Leopard and has a black dot within its spots. Furthermore, the Jaguar is biologically closer to Tigers. The Jaguar is the only Panthera in the Americas.”

The contents described above can be divided into several key concepts: “Jaguar”, “Panthera”, “Felidae”, “The only Panthera in the Americas”, etc.

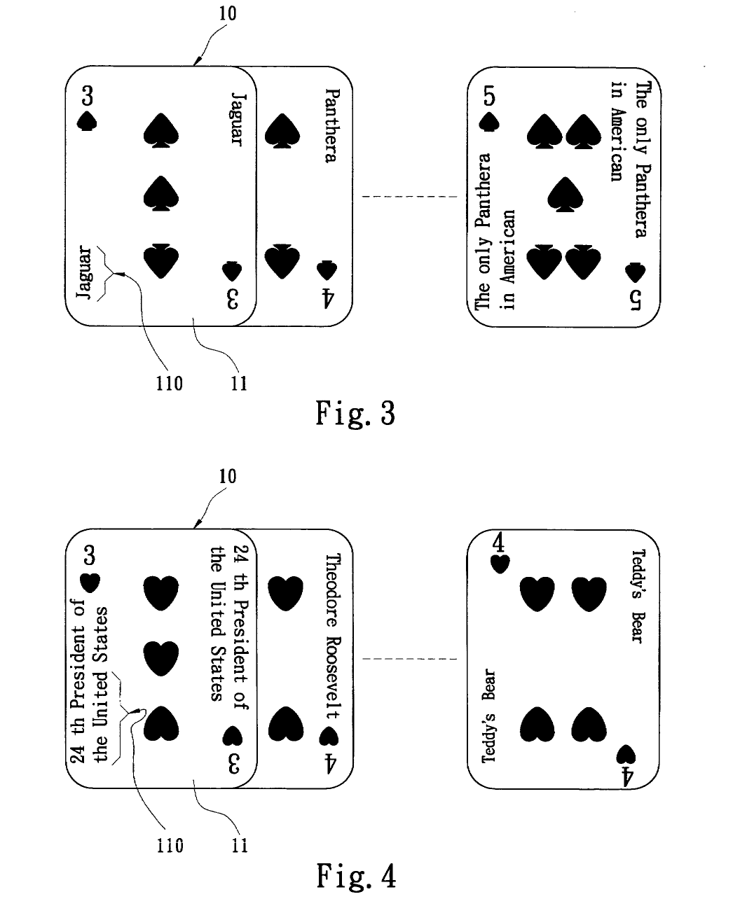

Record each key concept on the obverse side 11 of one playing card 10 of a group of several cards so as to become a deck of playing cards for learning about Jaguars, as shown in FIG. 3.

### EXAMPLE II

### Educational Topic: Teddy Bear History

“In November 1902 Theodore Teddy Roosevelt, 26^{th} President of the United States, was hunting in Mississippi. The President failed to make a kill so his hosts caught and tethered a bear, presenting it to the President as a sitting target. Naturally the President refused, uttering the immortal words, ‘Spare the bear! I will not shoot a tethered animal.’ Clifford Berryman drew a cartoon of the scene, which was published in the Washington Post.

That same month Brooklyn shopkeepers Morris and Rose Michtom made a soft bear toy, Morris wrote to the president requesting permission to call the hand made bears “Teddy's Bears”. The President replied giving his permission, but added that he did not think that using his name would help sell the bears.

America went bear mad almost overnight, the profit from the sale of these bears started what later became the Ideal Toy Co.”

The contents described above can be divided into several key concepts: “26^{th} President of the United states”, “Theodore Roosevelt”, “Teddy's Bear”, “Spare the bare”, etc.

Record each key concept on the obverse side 11 of one playing card 10 of a group of several cards so as to become a deck of playing cards for learning about “Teddy Bear History”, as shown in FIG. 4.

### “Playing Method”

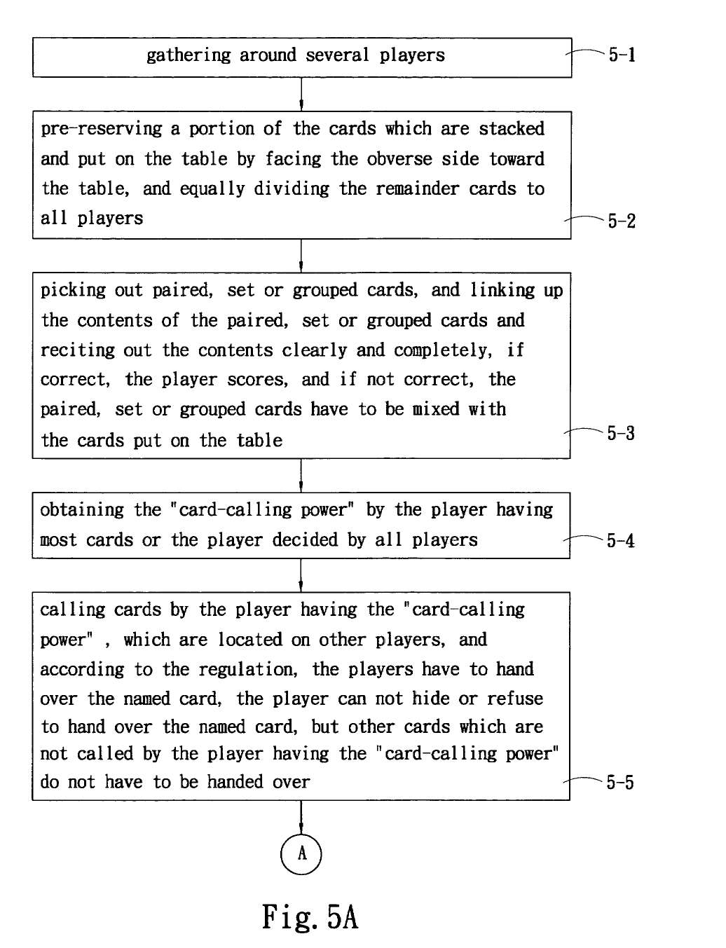

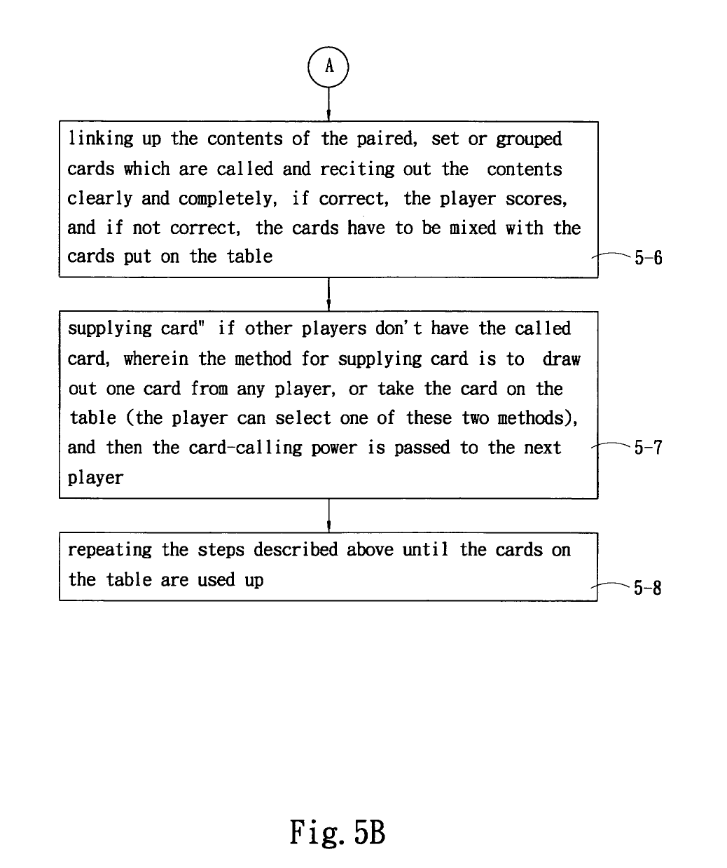

The method of play in a preferred embodiment of the present invention as shown in FIGS. 5A and 5B includes the following steps:

5-1. Gather several players. The number of players will be based on the number of cards available, more cards may allow for more players;

5-2. Reserve a portion of the cards and stack them face-down on the table (with the obverse side toward the table). This will be the draw deck. Then, equally divide the remaining cards to all players. The exact number of cards reserved and distributed will be based on the number of cards available (and the number of educational topics represented by the cards) as well as the number of players;

5-3. Each player then removes the cards in his/her hand that form a pair, a set or a group (please refer to the definition of pair, set and group below). In order for the player to obtain points, he/she must correctly say out loud what the association is between each collection of paired, set, or grouped cards. If the player succeeds, the cards are placed on the table in front of the player, and the player is awarded points. However, if the player fails, then the cards must be shuffled back into the cards on the table (the draw deck);

5-4. After Step 5-3, the player with the largest number of cards left goes first, or alternatively the players may choose together the player who can go first;

5-5. During each player's turn, he/she requests exactly one of the cards that he/she needs in order to form a pair, a set or a group. For example, if the player has the “Jaguar” card, he/she can request either the “Panthera” card or the “Felid” card. If another player has the requested card in his/her hand, he/she must hand over the named card. Note that the requested card must complete a pair, set or group;

5-6. In order for the player to obtain points, he/she must correctly say out loud what the association is between the paired, set, or grouped cards. If the player succeeds, the cards are placed on the table in front of the player, and the player is awarded points. However, if the player fails, then the cards must be shuffled back into the cards on the table (the draw deck). For example, the player must say clearly, [“Jaguar” is a member of the “Panthera” genus in the “Felidae”] family. The player's turn is then concluded and is the next player's turn;

5-7. If none of the other players have the requested card, the player may draw a random card from any one of the other players, or draw a card from the draw deck on the table. (The player may select one of either of these two methods.) The player's turn is then concluded and is the next player's turn;

5-8. Repeat the steps described above until all of the cards on the table are used up. The players then tally up their points based on the number of pairs, sets, and groups each player was able to form.

According to the rules specified in the preferred embodiment of the present invention, when a player requests a particular card during his/her turn, the player(s) who hold(s) the named card must hand over the card. The manner in which a player draws a card when necessary (from another player's hand, or from the draw deck) is also one way to randomly test for cheating. If a player is caught cheating, he/she is disqualified.

The definition of paired, set or grouped cards is as follows:

Paired: Two associated cards form a pair. For example, the cards for “26^{th} President of the United States” and “Theodore Roosevelt” form a pair.

Set: Three associated cards form a set. For example, the cards for “Jaguar”, “Panthera” and “Felidae” form a set.

Grouped: Four or more associated cards form a group. For example, the cards for “Jaguar”, “Panthera”, “Felidae”, and “The only Panthera in the Americas” form a group.

The players decide on the values of each pair, set and group at the start of the game. One possible scoring method is to award 2 points for two cards, 3 points for three cards and so forth, but this is not limited by this invention.

In actual usage, if the topic is from a book, the deck of cards of the present invention can be used with the actual book, thus reinforcing the key concepts from the book after the players have read the book, thus improving retention of the material.

In the preferred embodiment, the present invention can be utilized within single educational topics, or across different topics. Cards from differing topics can often be associated with each other through either meaning or logic. Thus the players can exposed to a broad range of topics when the cards are played mixed together. Through game play, the players can expand their knowledge across several different areas, such as geography, history, life science, biology, literature, etc. as well as understand the interrelations between the different topics. Furthermore, since the game rules do not define exactly what areas can be associated with each other, the game is able to stimulate the student's creativity in linking related topics.

It is to be understood, however, that even though numerous characteristics and advantages of the present invention have been set forth above, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An educational card game, used to aid players in learning information or knowledge relating to an educational topic, comprising:
a deck of cards, with each card having an obverse side and a reverse side, wherein the obverse side has an information area, which records the information that represents a key concept, furthermore, the key concepts on at least two of the cards are mutually associated.

2. The educational card game as claimed in claim 1, wherein the information or knowledge can be part of or all of the contents of the educational topic.

3. The educational card game as claimed in claim 1, wherein the information or knowledge can be part of or all of the contents of two or more different educational topics.

4. The educational card game as claimed in claim 1, wherein the information or knowledge on the card can be represented as characters, symbols, figures, or any combination thereof.

5. The educational card game as claimed in claim 1, wherein the reverse sides of the cards have identical backgrounds or colors.

6. The educational card game as claimed in claim 1, wherein the reverse sides of the cards have a marking area for indicating the educational topic.

7. A method of playing the deck of educational playing cards, including the following steps:
A. Gathering several players;
B. Reserving a portion of the cards and stack them face-down on the table with the obverse side toward the table, it being the draw deck and then equally dividing the remaining cards to all players, and the exact number of cards reserved and distributed being based on the number of cards available and the number of educational topics represented by the cards as well as the number of players;
C. Each player removing the cards in his/her hand that form a pair, a set or a group, in order for the player to obtain points, he/she having to correctly say out loud what the association is between each collection of paired, set, or grouped cards, when the player succeeds, the cards are placed on the table in front of the player, and the player is awarded points, but when the player fails, then the cards must be shuffled back into the cards on the table (the draw deck);
D. The player with the largest number of cards left going first or alternatively the players choosing together the player who can go first;
E. During each player's turn, he/she requesting exactly one of the cards that he/she needs in order to form a pair, a set or a group, and when another player has the requested card in his/her hand, he/she must hand over the named card, the requested card having to compete a pair, set or group;
F. In order for the player to obtain points, he/she having to correctly say out loud what the association is between the paired, set, or grouped cards, when the player succeeds, the cards are placed on the table in front of the player, and the player is awarded points, but when the player fails, the cards must be shuffled back into the cards on the table (the draw deck), the player's turn being then concluded and is the next player's turn;
G. If none of the other players have the requested card, the player may draw a random card from any one of the other players, or draw a card from the draw deck on the table, the player enabling to select one of either of these two methods, and the player's turn being then concluded and being the next player's turn; and
H. Repeating the steps described above until all of the cards on the table being used up, the players then tallying up their points based on the number of pairs, sets, and groups each player being able to form.
